(19) United States
(12) Patent Application Publication
(10) Pub. No.: US 2024/0370576 A1
(43) Pub. Date: Nov. 7, 2024

(54) CLOUD HARD DISK ENCRYPTION METHOD, APPARATUS AND SYSTEM, CLOUD HARD DISK DECRYPTION METHOD, APPARATUS AND SYSTEM, AND READABLE STORAGE MEDIUM

(71) Applicant: SUZHOU METABRAIN INTELLIGENT TECHNOLOGY CO., LTD., Suzhou, Jiangsu (CN)

(72) Inventor: Wen HUO, Suzhou, Jiangsu (CN)

(21) Appl. No.: 18/563,847

(22) PCT Filed: Apr. 28, 2022
(86) PCT No.: PCT/CN2022/089875

§ 371 Date: Nov. 22, 2023

(30) Foreign Application Priority Data
Oct. 9, 2021 (CN) 202111173558.6

(51) Int. Cl. G06F 21/60; G06F 21/64; G06F 21/80

(52) U.S. Cl. CPC G06F 21/602; G06F 21/64; G06F 21/80

(57) ABSTRACT

A method, apparatus and system for encrypting and decrypting a cloud hard disk encryption, and a computer-readable storage medium. The method comprises: calling a pre-established encrypted disk according to an operation request (S110); sending acquired operation data to a target encryptor via a corresponding operation interface in an encryptor adaptation library, so that the target encryptor performs a corresponding operation on the operation data (S120); and receiving, via the operation interface, an operation result that is returned by the target encryptor to a server (S130).

### CROSS-REFERENCE TO RELATED APPLICATION

The present disclosure claims priority to Chinese patent application No. 202111173558.6, filed on Oct. 9, 2021 before the China National Intellectual Property Administration, titled “METHOD, APPARATUS AND SYSTEM FOR ENCRYPTING AND DECRYPTING CLOUD HARD DISK, AND COMPUTER-READABLE STORAGE MEDIUM”, which is incorporated herein in its entirety by reference.

### TECHNICAL FIELD

The present disclosure relates to the technical field of cloud computing and, in particular to a method, apparatus and system for encrypting and decrypting a cloud hard disk, and a computer-readable storage medium.

### BACKGROUND

In recent years, cloud computing has gradually become a prominent development trend in the industry. Cloud computing-backed system virtualization may not only help cloud service providers deploy fewer servers and optimize resource exploitation but also provide users with flexible infrastructure configurations, thereby reducing costs and rendering rapid responses to changes in demand. However, with the cloudification of business systems, data security issues in the systems have been a growing concern.

### SUMMARY

It is an object of embodiments of the present disclosure to provide a method, apparatus and system for encrypting and decrypting a cloud hard disk, and a computer-readable storage medium.

To solve the above technical problems, an embodiment of the present disclosure provides a method for encrypting and decrypting a cloud hard disk, including:
calling a pre-established encrypted disk in response to an operation request;
transmitting, via a corresponding operation interface in an encryptor adaptation library, acquired operation data to a target encryptor, so that the target encryptor performs a corresponding operation on the operation data; and
receiving, via the operation interface, an operation result returned by the target encryptor.

In some embodiments, the encryptor adaptation library is established by:
establishing operation interfaces respectively corresponding to various operation types, wherein the operation interfaces are configured to establish connections with encryptors; and
adding identification codes corresponding to the encryptors to a pre-established encryptor resource pool.

In some embodiments, the encrypted disk is established by:
for each computation, acquiring parameter information about the computation;
configuring a corresponding operation interface in the encryptor adaptation library according to the parameter information to obtain interface information about the operation interface;
adding each interface information obtained to encrypted disk header information about the encrypted disk to be established, creating and obtaining the encrypted disk.

In some embodiments, a process of transmitting, via a corresponding operation interface in an encryptor adaptation library, acquired operation data to a target encryptor includes:
determining the target encryptor according to the pre-established encryptor adaptation library;
determining a target operation interface among the operation interfaces according to an operation type of the operation request and the encrypted disk header information about the encrypted disk; and
transmitting the acquired operation data to the encryptor via the target operation interface.

In some embodiments, a process of determining the target encryptor according to the pre-established encryptor adaptation library includes:
determining encryptors respectively corresponding to the identification codes in the encryptor resource pool; and
determining idle encryptors among the encryptors, and determining the target encryptor among the idle encryptors.

In some embodiments, the operation interface is one of an initialization interface, a symmetric encryption algorithm encryption/decryption interface, an asymmetric encryption algorithm key generation interface, an asymmetric encryption algorithm encryption/decryption interface, an asymmetric encryption algorithm signature/verification signature interface, a Hash/HMCA interface, a random number generation interface, and an encryptor disabling interface.

In some embodiments, the method further includes:
in response to receiving an operation ending message, turning off the target encryptor through a corresponding interface of the encryptor adaptation library.

In some embodiments, the method further includes:
determining an operation type according to the operation request.

An embodiment of the present disclosure further provides an apparatus for encrypting and decrypting a cloud hard disk, including:
a calling module, configured to call a pre-established encrypted disk in response to an operation request;
a transmission module, configured to transmit, via a corresponding operation interface in an encryptor adaptation library, acquired operation data to a target encryptor, so that the target encryptor performs a corresponding operation on the operation data; and
a reception module, configured to receive, via the operation interface, an operation result returned by the target encryptor.

An embodiment of the present disclosure further provides a system for encrypting and decrypting a cloud hard disk, including:
a memory configured to store a computer program; and
a processor configured to that, when executing the computer program, implements steps of the method for encrypting and decrypting a cloud hard disk described above.

In some embodiments, the encryptor adaptation library is established by:
establishing operation interfaces respectively corresponding to various operation types, wherein the operation interfaces are configured to establish connections with encryptors; and
adding identification codes corresponding to the encryptors to a pre-established encryptor resource pool.

In some embodiments, the encrypted disk is established by:
for each computation, acquiring parameter information about the computation;
configuring a corresponding operation interface in the encryptor adaptation library according to the parameter information to obtain interface information about the operation interface;
adding each interface information obtained to encrypted disk header information about the encrypted disk to be established, creating and obtaining the encrypted disk.

In some embodiments, the transmission module is further configured to: determine an operation type according to the operation request.

An embodiment of the present disclosure further provides a computer-readable storage medium storing a computer program that, when executed by a processor, implements steps of the method for encrypting and decrypting a cloud hard disk described above.

In an embodiment of the present disclosure, a method, apparatus and system for encrypting and decrypting a cloud hard disk, and a computer-readable storage medium are provided, and the method includes: calling a pre-established encrypted disk in response to an operation request; transmitting, via a corresponding operation interface in an encryptor adaptation library, acquired operation data to a target encryptor, so that the target encryptor performs a corresponding operation on the operation data; and receiving, via the operation interface, an operation result that is returned by the target encryptor to a server.

### BRIEF DESCRIPTION OF THE DRAWINGS

In order to explain technical solutions of embodiments of the present disclosure more clearly, a brief description will be given below regarding the accompanying drawings that are necessary for the description of the related art and the embodiments of the present disclosure. Apparently, the drawings in the following description are only some embodiments of the present disclosure, and those skilled in the art may obtain other drawings based on these drawings without involving any creative effort.

FIG. 1 is a schematic flow chart of a method for encrypting and decrypting a cloud hard disk according to an embodiment of the present disclosure;

FIG. 2 is a schematic structural diagram illustrating an apparatus for encrypting and decrypting a cloud hard disk according to an embodiment of the present disclosure;

FIG. 3 is a schematic structural diagram illustrating a system for encrypting and decrypting a cloud hard disk according to an embodiment of the present disclosure; and

FIG. 4 is a schematic structural diagram illustrating a computer-readable storage medium according to an embodiment of the present disclosure.

### DETAILED DESCRIPTION

The embodiments of the present disclosure provide a method, apparatus and system for encrypting and decrypting a cloud hard disk, and a computer-readable storage medium, that are beneficial for improving the service operation efficiency and server performance in use.

In order that the object, aspects and advantages of the embodiments of the present disclosure will become more apparent, a more complete description of the embodiments of the present disclosure will be rendered by reference to the appended drawings, which are provided to illustrate, by way of example, some, but not all embodiments of the present disclosure. Based on the embodiments of the present disclosure, all other embodiments obtained by those skilled in the art without creative effort fall within the scope of the present disclosure.

Most public clouds and private clouds are developed based on OpenStack, an open-source cloud computing management platform project, which combines a series of software open-source projects. Cloud disk encryption means that when OpenStack calls, via libvirt, an open-source application programming interface (API) for managing virtualization platforms, qemu-kvm to create a disk file to be loaded by a cloud operating system, the entire disk is encrypted through an encryption algorithm. As such, data security is achieved.

Currently, there are four approaches to the encryption and decryption of disk files in qemu-kvm, namely, qemu built-in encryption algorithm (e.g., builtin/glibc), calling a kernel encryption module, calling a nettle library, and calling a libgcrypt library. These four encryption and decryption approaches are all implemented at a hypervisor (virtual machine monitor) layer, which greatly reduces the performance of the hypervisor, not to mention the huge loss incurred in data reading and writing due to the fact that the encryption and decryption process and business data are both run on a server and the encryption/decryption is conducted for the entire disk data. As shown in a business data pressure test, in the case of using the nettle library to encrypt and decrypt data, the loss in reading and writing reaches more than 50% as compared with the case where the data is not encrypted in reading and writing and AES-256 is taken to encrypt and decrypt the disk data. This is difficult to meet the business requirements of cloud hard disk with a large volume of data, affects the business operation on the server seriously, and reduces the server performance.

In view of the above, a problem to be solved by those skilled in the art is to provide a method, apparatus and system for encrypting and decrypting a cloud hard disk, and a computer-readable storage medium capable of solving the above-mentioned technical problem.

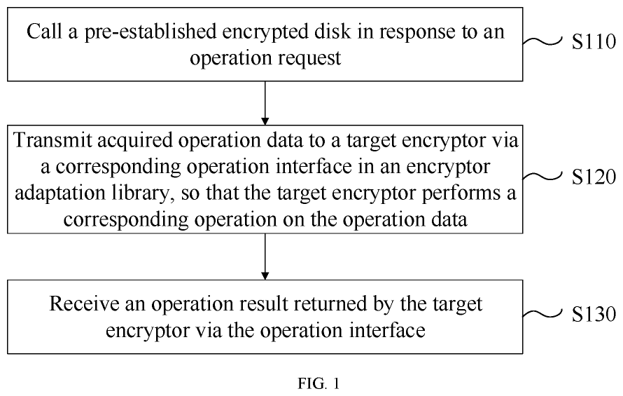

Referring to FIG. 1, which is a schematic flow chart of a method for encrypting and decrypting a cloud hard disk according to an embodiment of the present disclosure, the method includes steps below.

In step S110, a pre-established encrypted disk is called in response to an operation request.

It should be noted that in the embodiment of the present disclosure, an encryptor adaptation library is pre-established. The encryptor adaptation library is configured to provide an operation interface for calling an encryptor to an upper layer, so that the upper layer calls a corresponding encryptor by calling the operation interface in the encryptor adaptation library to complete a corresponding operation, such as encryption/decryption and signature verification.

In some embodiments, in practical applications, the encrypted disk is pre-established, and called in response to the received operation request.

In step S120, acquired operation data is transmitted to a target encryptor via a corresponding operation interface in the encryptor adaptation library, so that the target encryptor performs a corresponding operation on the operation data.

In some embodiments, to perform a data read/write operation on the encrypted disk, operation data is acquired, and the target encryptor operating on the operation data is determined: the acquired operation data is then transmitted to the target encryptor via a corresponding operation interface in the encryptor adaptation library: after receiving the operation data, the target encryptor performs a corresponding operation on the operation data, wherein operation interfaces correspond to operation types, and regarding which operation is to be specifically executed, the operation type may be determined in response to the operation request, and then the operation interface required to be called is determined according to the operation type. Next, the target encryptor is called via the operation interface, and the target encryptor is enabled to execute the operation corresponding to the operation type on the operation data; after the execution is completed, the encryptor returns the operation result via the corresponding operation interface.

In step S130, an operation result returned by the target encryptor is received via the operation interface.

In some embodiments, the operation result returned by the target encryptor is received via the operation interface in the encryptor adaptation library, and subsequent operations are further performed on the operation result according to the operation type of a specific read/write operation on the encrypted disk. For example, for the encryption operation, the acquired operation data is data to be stored to the encrypted disk, and the encryptor is required to perform the encryption operation on the operation data; the resultant operation result is encrypted data, and the encrypted data is received through the operation interface in the encryptor adaptation library and written to the encrypted disk.

It can be seen that, in the embodiment of the present disclosure, upon the reception of an operation request, the pre-established encrypted disk is called, and then the acquired operation data is transmitted to the target encryptor via the corresponding operation interface in the pre-established encryptor adaptation library; after the operation data is received, the target encryptor executes the corresponding operation on the operation data to obtain the operation result, and returns the operation result via the corresponding operation interface. In the present disclosure, when the encryption/decryption operation is performed on the disk file, the operation data is transmitted to the encryptor to be encrypted/decrypted, which avoids the problem that the encryption/decryption operation performed on the server may occupy server resources and improves the service operation efficiency and server performance.

On the basis of the above-mentioned embodiment, furthermore, the above-mentioned encryptor adaptation library may be established by:
establishing operation interfaces respectively corresponding to various operation types, the operation interfaces being configured to establish connections with encryptors; and
adding identification codes corresponding to the encryptors to a pre-established encryptor resource pool.

It should be noted that, in the embodiment of the present disclosure, different operation interfaces may be configured for different operation types in the encryptor adaptation library. Therefore, when an encryptor is called via an operation interface, the operation type may be determined according to the specific operation interface used. The encryptor resource pool may also be established in the encryptor adaptation library, and for different encryptors, the identification code corresponding to the encryptor may be added to the encryptor resource pool.

In practical applications, the encryptor adaptation library, e.g., libgeneralhsm.so, may be a dynamic link library compiled in C/C++ to adapt to encryptors of different manufacturers; libgeneralhsm.so is encapsulated with functional interfaces provided by encryptors of different manufacturers, so that upper-layer applications such as qemu-img and qemu-kvm may directly call the interfaces provided by libgeneralhsm.so to the upper-layer applications by referring to the libgeneralhsm.so library and header files, thereby calling the encryptor to complete operations such as encryption/decryption and signature verification. Libgeneralhsm.so offers the same interfaces to the upper-layer application for the encryptors of different manufacturers; the upper-layer application has no perception of which manufacturer's encryptor is used at all, and the influence of different encryptors on the upper-layer application may be ignored. Moreover, by creating the encryptor resource pool, libgenerahsm.so may support multiple encryptors to simultaneously perform encryption/decryption operations, and may linearly improve the speed of encryption/decryption operations to a certain extent. Herein, when the encryptor is called via the encryptor adaptation library, a function interface of the target encryptor may be called via an operation interface corresponding to the operation type so as to realize the calling of the encryptor. The operation interfaces of different operation types provided by the encryptor adaptation library may include an initialization interface, a symmetric encryption algorithm encryption/decryption interface, an asymmetric encryption algorithm key generation interface, an asymmetric encryption algorithm encryption/decryption interface, an asymmetric encryption algorithm signature/signature verification interface, a Hash/HMCA interface, a random number generation interface, and an encryptor disabling interface.

It is to be further noted that in practical applications, when the encryptor adaptation library as the encryptor resource pool is called by an upper-layer application, a library configuration file may be read by calling the initialization encryptor interface to acquire configuration information such as IP, port, password, and the bottom-layer of the encryptor of all available encryptors, and then the encryptor is called to open a password device interface to acquire a device handle (in particular, the encryptor generates one device handle), and then the device handle is added into an array HSMPool of the encryptor resource pool, where the HSMPool is a global variable, and the device handles of all available encryptors in the encryptor adaptation library are stored in the HSMPool for subsequent use. When the encryptor adaptation library is called by the upper-layer application through, for example, the encryption, decryption, signature, signature verification, and Hash/HMAC interfaces and the random number generation interface, firstly, an available device handle in the encryptor resource pool array HSMPool is randomly acquired; next, a session handle is created according to the device handle, and a service interface of the encryptor is called in the session handle, thus completing the functions of the encryption, decryption, signature, signature verification, and Hash/HMAC interfaces and random number generation, and returning same to the upper-layer application; finally, the session handle is closed. When the encryptor disabling interface is called by the upper-layer application, the encryptor adaptation library libgereralhsm.so acquires the encryption device handles in the encryptor resource pool array HSMPool sequentially and calls the encryptor disabling interface sequentially to shut down all the encryptor links.

In some embodiments, the encrypted disk in the embodiment of the present disclosure may be established by:
for each computation, acquiring parameter information corresponding to the computation;
configuring the corresponding operation interface in the encryptor adaptation library according to the parameter information to obtain interface information about the operation interface;
adding each interface information obtained to encrypted disk header information about the encrypted disk to be established, and creating and obtaining the encrypted disk.

It should be noted that before creating the encrypted disk, it is also possible to choose whether to enable the function of the encryptor adaptation library according to needs, and if the function is enabled, the encrypted disk is established according to the method provided in the present disclosure, wherein when creating the encrypted disk using qemu-img in qemu, the following codes may be added to the configure file:

| | |
|---|---|
| 1. | |
| 2. | --disable-generalhsm) generalhsm=“no” |
| 3. | ;; |
| 4. | --enable-generalhsm) generalhsm=“yes” |
| 5. | |
| 6. | |
| 7. | if test “$ generalhsm” = “yes” ; then |
| 8. | echo “CONFIG_GENERALHSM=y” >> $config_host_mak |
| 9. | fi |
| 10. | |

That is, if “--enable-generalhsm” is included in the parameters of the configure file, then the encryptor adaptation library libgeneralhsm.so is referrenced as a cloud hard disk encryption/decryption source, without using other means such as nettle and libgcrypt. Then, when the qemu-img, an executable file, starts, in the qcrypto_init ( ) function, the initialization interface of the libgeneralhsm.so library is called to initialize all the available encryptors to keep them in the available state.

In practical applications, the computation of the encrypted disk involved in Qe-img may be one of cipher, hash, hmac, pbkdf or random, and for each computation, corresponding parameter information is acquired and, according to the parameter information, the function to be called may also be determined and the corresponding operation interface in the encryptor adaptation library may be configured, so as to obtain interface information about the operation interface, that is, which operation interface is to be configured depends on which computation parameter information corresponds to which operation interface; therefore, information about a plurality of interfaces may be obtained, and then information about each interface is added to the encrypted disk header information, thereby creating the encrypted disk.

Cipher is taken as an example, and may be created by the following codes:

| | |
|---|---|
| 1. | |
| 2. | #ifdef CONFIG_GCRYPT |
| 3. | #include “cipher-gcrypt.c” |
| 4. | #elif defined CONFIG_NETTLE |
| 5. | #include “cipher-nettle.c” |
| 6. | #elif defined CONFIG_GENERALHSM |
| 7. | #include “ cipher-generalhsm.c ” |
| 8. | #else |
| 9. | #include “cipher-builtin.c” |
| 10. | #endif |
| 11. | |

That is, if the CONFIG_GENERALHSM macro is defined, the cipher-generalhsm.c file is referenced for an encryption/decryption operation of the cloud hard disk, and since the CONFIG_GENERALHSM macro is defined in the configure file, the cipher-generalhsm.c branch is taken here. In cipher-generalhsm.c, the libgeneralhsm.so library's encryption and decryption interface parameters are assembled on the basis of the different parameters input from qemu-img, and the interface information is written into the encrypted disk header information. Similarly, for the other four computations, namely, hash, hmac, pbkdf, and random, the corresponding interface parameters of the libgeneralhsm.so library are assembled on the basis of different parameters input from qemu-img, and the interface information is written into the encrypted disk header information, thus completing other operations finally to create the encrypted disk. As such, the encrypted disk is successfully created.

In some embodiments, in the S120, a process of transmitting the acquired operation data to the target encryptor via the corresponding operation interface in the pre-established encryptor adaptation library may include:
determining the target encryptor according to the pre-established encryptor adaptation library;
determining a target operation interface among the operation interfaces according to an operation type of the operation request and the encrypted disk header information about the encrypted disk; and
transmitting the acquired operation data to the encryptor via the target operation interface.

When the encrypted disk is used, the encrypted disk is called in response to the operation request, and then encryptors may be determined according to the identification codes respectively corresponding to the encryptors, among which idle encryptors are determined, that is, available encryptors are determined: an encryptor may be randomly determined among these idle encryptors as the target encryptor: then operation interface information corresponding to the operation type is determined according to the operation type and the encrypted disk header information: the target operation interface is further determined according to the operation interface information. The acquired operation data is then transmitted to the encryptor through the operation interface, so that the encryptor performs the corresponding operation on the operation data.

In addition, the above-mentioned description mentions that the device handles of all available encryptors may be added to the array HSMPool of the encryptor resource pool in advance; as such, when determining the target encryptor, the device handle may also be obtained randomly from the array HSMPool, and the encryptor corresponding to the device handle may be taken as the target encryptor.

Apparently, in practical applications, for example, in the case where qemu-kvm is taken to use the encrypted disk in qemu, upon loading the encrypted disk, the qemu-kvm firstly obtains an encryption mode employed by the qemu-kvm according to configuration parameters of the configure file, and in the embodiment herein, the encryption mode is to call the libgeneralhsm.so library. The initialization interface of the libgeneralhsm.so library may be called in the qcrypto_init ( ) function to initialize all available encryptors and keep them in the available state. Then, qemu-kvm reads the encrypted disk head information, acquires information such as an encryption algorithm, encryption mode, hash algorithm, hmac, pbkdf and random algorithms of the disk, and corresponding operation interfaces and parameters: the corresponding operation interface in the encryptor adaptation library libgeneralhsm.so may be called when the qemu-kvm needs to read data from and write data to the disk. In addition, when qemu-kvm exits, the disabling device interface of the libgeneralhsm.so library may be called to shut down the encryptor link and the target encryptor.

In the embodiment of the present disclosure, by calling a hardware encryptor, the encryption/decryption operation originally performed by qemu-kvm at the hypervisor layer is transferred to a special encryption/decryption device (namely, the encryptor), so as to greatly improve the performance of the system for encrypting and decrypting disk data. Moreover, the encryptor adaptation library libgeneralhsm.so library supports the common use of a plurality of encryptor devices, facilitating the horizontal expansion of the encryptor, and further improving the performance of the system. Encrypting and decrypting the disk data in the hardware encryptor special for the encryption/decryption operation avoid the theft or interception of sensitive data by illegal molecules and ensure the security of the system data. In addition, the encryptor adaptation library libgeneralhsm.so in the embodiment of the present disclosure supports the common use of a plurality of encryptor devices, and the encryptor may be extended horizontally to do main and standby operations without affecting the use of the system due to the damage of certain encryptor device, hence the system has a high availability. The encryptor adaptation library libgeneralhsm.so provides adaptation to a plurality of encryptor devices of different manufacturers and a uniform interface for external connection, hence the upper-layer application does not need to replace the underlying encryptor and modify the source code for compatibility, that is, the encryptor adaptation library libgeneralhsm.so has universality.

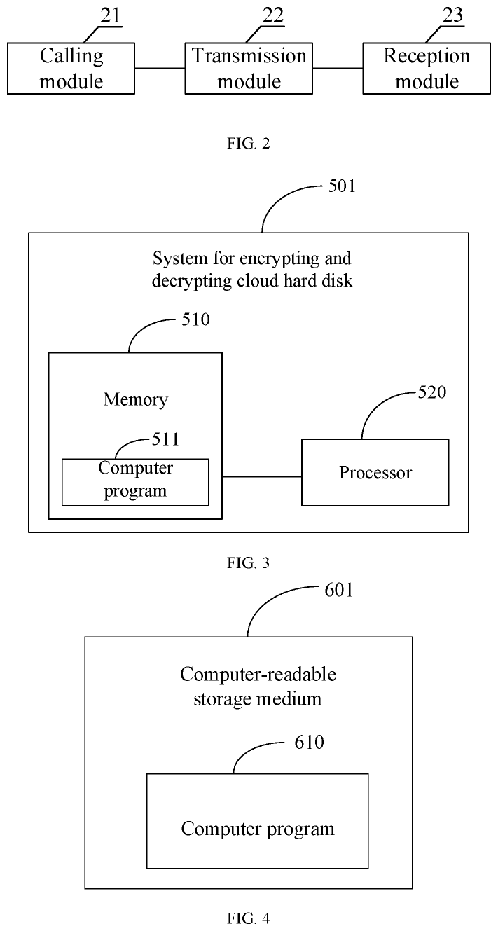

On the basis of the above-mentioned embodiments, an apparatus for encrypting and decrypting a cloud hard disk is further provided in an embodiment of the present disclosure, and with reference to FIG. 2 for details, the apparatus includes:
a calling module 21 configured to call a pre-established encrypted disk in response to an operation request;
a transmission module 22 configured to transmit, via a corresponding operation interface in an encryptor adaptation library, acquired operation data to a target encryptor, so that the target encryptor performs a corresponding operation on the operation data; and
a reception module 23 configured to receive an operation result returned by the target encryptor via the operation interface.

It should be noted that the apparatus for encrypting and decrypting a cloud hard disk provided in the embodiments of the present disclosure has the same advantageous effects as the method for encrypting and decrypting a cloud hard disk provided in the above-mentioned embodiments: for a detailed description of the method for encrypting and decrypting a cloud hard disk involved in this embodiment of the present disclosure, reference shall be made to the above-mentioned embodiment, and the description thereof will not be repeated here.

Reference is made to FIG. 3, which is a schematic structural diagram illustrating a system for encrypting and decrypting a cloud hard disk provided by an embodiment of the present disclosure. On the basis of the above-mentioned embodiment, a system for encrypting and decrypting a cloud hard disk 501 is further provided in the embodiment of the present disclosure, including:
a memory 510 configured to store a computer program 511; and
a processor 520 configured to, when executing the computer program 511, implement the steps of the method for encrypting and decrypting a cloud hard disk as described above.

For example, the processor in the embodiment of the present disclosure may be particularly configured to implement the method, apparatus and system for encrypting and decrypting a cloud hard disk, and the computer-readable storage medium herein, the method including: calling a pre-established encrypted disk in response to an operation request; transmitting acquired operation data to a target encryptor via a corresponding operation interface in an encryptor adaptation library, so that the target encryptor performs a corresponding operation on the operation data; and receiving, via the operation interface, an operation result that is returned by the target encryptor to a server.

Reference is made to FIG. 4, which is a schematic structural diagram of a computer-readable storage medium provided by an embodiment of the present disclosure. On the basis of the above-mentioned embodiment, a computer-readable storage medium 601 is further provided in the embodiment of the present disclosure. The computer program 610 is stored in the computer-readable storage medium 601 and, when executed by the processor, the computer program 610 implements the steps of the method for encrypting and decrypting a cloud hard disk as mentioned above.

The computer-readable storage medium may include various media capable of storing the program code, such as a USB drive, removable hard disk, read-only memory (ROM), random access memory (RAM), and magnetic or optical disk.

Various embodiments in the specification are described in a progressive manner, each embodiment focuses on the difference from other embodiments, and the same and similar parts of various embodiments can be referred to each other. Since the apparatus disclosed in the embodiments corresponds to the method disclosed in the embodiments, the description thereof is relatively simple, and for relevant details, please refer to the description of the method.

It should also be noted that relational terms such as “first”, “second” as used herein are merely used to distinguish an object or operation from another object or operation, and are not necessarily used to describe or imply that such an actual relationship or sequence exists between these objects and operations. Furthermore, the terms “comprising” and “having”, as well as any variations thereof, are intended to cover a non-exclusive inclusion, e.g., a process, method or apparatus comprising a series of steps or elements is not necessarily limited to those elements explicitly listed, but may include other elements not explicitly listed or inherent to the process, method or apparatus. Without further limitations, an element defined by the phrase “comprising a . . . ” does not exclude the presence of additional identical elements in the process, method, article or apparatus comprising said element.

The above description of the disclosed embodiments is provided to enable those skilled in the art to make or use the present application. Various modifications to these embodiments will be readily apparent to those skilled in the art, and the general principles defined herein may be implemented in other embodiments without departing from the spirit or scope of the application. Therefore, the present application will not be limited to the embodiments shown herein, but is to be accorded the widest scope consistent with the principles and novel features disclosed herein.

1. A method for encrypting and decrypting a cloud hard disk, comprising:
calling a pre-established encrypted disk in response to an operation request;
transmitting, via a corresponding operation interface in an encryptor adaptation library, acquired operation data to a target encryptor, so that the target encryptor performs a corresponding operation on the operation data; and
receiving, via the operation interface, an operation result returned by the target encryptor.

2. The method for encrypting and decrypting a cloud hard disk according to claim 1, wherein the encryptor adaptation library is established by:
establishing operation interfaces respectively corresponding to various operation types, wherein the operation interfaces are configured to establish connections with encryptors; and
adding identification codes corresponding to the encryptors to a pre-established encryptor resource pool.

3. The method for encrypting and decrypting a cloud hard disk according to claim 2, wherein the encrypted disk is established by:
for each computation, acquiring parameter information about the computation;
configuring a corresponding operation interface in the encryptor adaptation library according to the parameter information to obtain interface information about the operation interface;
adding each interface information obtained to encrypted disk header information about the encrypted disk to be established, creating and obtaining the encrypted disk.

4. The method for encrypting and decrypting a cloud hard disk according to claim 2, wherein a process of transmitting, via a corresponding operation interface in an encryptor adaptation library, acquired operation data to a target encryptor comprises:
determining the target encryptor according to the pre-established encryptor adaptation library;
determining a target operation interface among the operation interfaces according to an operation type of the operation request and the encrypted disk header information about the encrypted disk; and
transmitting the acquired operation data to the target encryptor via the target operation interface.

5. The method for encrypting and decrypting a cloud hard disk according to claim 4, wherein a process of determining the target encryptor according to the pre-established encryptor adaptation library comprises:
determining encryptors respectively corresponding to the identification codes in the encryptor resource pool; and
determining idle encryptors among the encryptors, and determining the target encryptor among the idle encryptors.

6. The method for encrypting and decrypting a cloud hard disk according to claim 2, wherein the operation interface is one of an initialization interface, a symmetric encryption algorithm encryption/decryption interface, an asymmetric encryption algorithm key generation interface, an asymmetric encryption algorithm encryption/decryption interface, an asymmetric encryption algorithm signature/verification signature interface, a Hash/HMCA interface, a random number generation interface, and an encryptor disabling interface.

7. The method for encrypting and decrypting a cloud hard disk according to claim 1, further comprising:
in response to receiving an operation ending message, disabling the target encryptor through a corresponding interface of the encryptor adaptation library.

8. The method for encrypting and decrypting a cloud hard disk according to claim 1, further comprising:
determining an operation type according to the operation request.

9-12. (canceled)

13. A apparatus for encrypting and decrypting a cloud hard disk, comprising:
a memory configured to store a computer program; and
a processor that, when executing the computer program, implements operations of:
calling a pre-established encrypted disk in response to an operation request;
transmitting, via a corresponding operation interface in an encryptor adaptation library, acquired operation data to a target encryptor, so that the target encryptor performs a corresponding operation on the operation data; and
receiving, via the operation interface, an operation result returned by the target encryptor.

14. A non-transient computer-readable storage medium storing a computer program that, when executed by a processor, implements operations of;
calling a pre-established encrypted disk in response to an operation request;
transmitting, via a corresponding operation interface in an encryptor adaptation library, acquired operation data to a target encryptor, so that the target encryptor performs a corresponding operation on the operation data; and
receiving, via the operation interface, an operation result returned by the target encryptor.

15. The method for encrypting and decrypting a cloud hard disk according to claim 1, wherein the encryptor adaptation library is adapted to encryptors of different manufacturers, and is encapsulated with functional interfaces provided by encryptors of different manufacturers.

16. The method for encrypting and decrypting a cloud hard disk according to claim 2, wherein the encryptor adaptation library is configured to support multiple encryptors to simultaneously perform an encryption operation or a decryption operation based on the encryptor resource pool.

17. The method for encrypting and decrypting a cloud hard disk according to claim 4, wherein a process of determining the target encryptor according to the pre-established encryptor adaptation library comprises:
randomly obtaining a device handle from an array HSMPool of the encryptor resource pool, and determining the encryptor corresponding to the device handle as the target encryptor.

18. The apparatus for encrypting and decrypting a cloud hard disk according to claim 13, wherein the encryptor adaptation library is established by:
establishing operation interfaces respectively corresponding to various operation types, wherein the operation interfaces are configured to establish connections with encryptors; and
adding identification codes corresponding to the encryptors to a pre-established encryptor resource pool.

19. The apparatus for encrypting and decrypting a cloud hard disk according to claim 18, wherein the encrypted disk is established by:
for each computation, acquiring parameter information about the computation;
configuring a corresponding operation interface in the encryptor adaptation library according to the parameter information to obtain interface information about the operation interface;
adding each interface information obtained to encrypted disk header information about the encrypted disk to be established, creating and obtaining the encrypted disk.

20. The apparatus for encrypting and decrypting a cloud hard disk according to claim 18, wherein the processor is further configured to implement operations of:
determining the target encryptor according to the pre-established encryptor adaptation library;
determining a target operation interface among the operation interfaces according to an operation type of the operation request and the encrypted disk header information about the encrypted disk; and
transmitting the acquired operation data to the target encryptor via the target operation interface.

21. The apparatus for encrypting and decrypting a cloud hard disk according to claim 20, wherein the processor is further configured to implement operations of:
determining encryptors respectively corresponding to the identification codes in the encryptor resource pool; and
determining idle encryptors among the encryptors, and determining the target encryptor among the idle encryptors.

22. The apparatus for encrypting and decrypting a cloud hard disk according to claim 18, wherein the operation interface is one of an initialization interface, a symmetric encryption algorithm encryption/decryption interface, an asymmetric encryption algorithm key generation interface, an asymmetric encryption algorithm encryption/decryption interface, an asymmetric encryption algorithm signature/verification signature interface, a Hash/HMCA interface, a random number generation interface, and an encryptor disabling interface.

23. The apparatus for encrypting and decrypting a cloud hard disk according to claim 13, wherein the processor is further configured to implement operations of:
in response to receiving an operation ending message, disabling the target encryptor through a corresponding interface of the encryptor adaptation library.

24. The apparatus for encrypting and decrypting a cloud hard disk according to claim 13, the processor is further configured to implement operations of:
determining an operation type according to the operation request.
